(19) United States
(12) Patent Application Publication
(10) Pub. No.: US 2008/0238357 A1
(43) Pub. Date: Oct. 2, 2008

(54) ULTRA FAST BATTERY CHARGER WITH BATTERY SENSING

(76) Inventors: Jordan T. Bourilkov, Stamford, CT (US); David N. Klein, Southbury, CT (US); John Rotondo, Trumbull, CT (US); David C. Batson, Winchester, MA (US)

Correspondence Address: FISH & RICHARDSON P.C., P.O. BOX 1022, MINNEAPOLIS, MN, 55440-1022, US

(21) Appl. No.: 11/776,261

(22) Filed: Jul. 11, 2007

Related U.S. Application Data
(60) Provisional application No. 60/908,008, filed on Mar. 26, 2007.

(51) Int. Cl. H02J 7/00

(52) U.S. Cl. 320/106; 320/107; 320/162

(57) ABSTRACT

Disclosed is a method for charging a rechargeable battery having at least one rechargeable electrochemical cell. The method includes determining a corresponding battery capacity based on identification information received from the rechargeable battery, determining a charging current level to apply to the rechargeable battery based on the determined corresponding battery capacity such that the battery achieves a pre-determined charge that is reached within a charging period of time of 15 minutes or less, and applying a charging current having substantially about the determined current level to the battery.

### CROSS-REFERENCE TO RELATED APPLICATIONS

This application claims priority to U.S. Provisional Application Ser. No. 60/908,008, entitled “Ultra Fast Battery Charger with Battery Sensing” and filed on Mar. 26, 2007, the content of which is hereby incorporated by reference in its entirety.

### BACKGROUND

Lithium-ion rechargeable batteries are charged by a source that provides a constant current followed by a constant voltage (CC/CV) with a crossover from constant voltage to constant current at approximately 4.2V (i.e., the charging operation switches from a constant current mode to a constant voltage mode when the battery's voltage reaches approximately 4.2V.) The source that provides such a charging profile is controlled by an electronic feedback mechanism. To charge a rechargeable battery within a given period of time, and to avoid damage to the battery due to the application of incorrect charging current; careful and accurate regulation of the charging device's charging mechanism is required. To facilitate accurate regulation of the charging current, accurate measurement of the battery's voltage and/or current is required. Furthermore, because batteries have different capacities and require different levels of charging currents accurate information regarding battery capacities is needed to enable completion of the charging operation within the given period of time and to avoid damaging the rechargeable battery and/or charger.

### SUMMARY

Disclosed is an ultra-last charger that can charge different rechargeable batteries and/or different charge capacities within a given, charging period of time, e.g., 5 minutes charge to 90% capacity.

in one aspect, a method for charging a rechargeable battery having at least one rechargeable electrochemical cell is disclosed. The method includes determining a corresponding battery capacity based on identification information received from the rechargeable battery, determining a charging current level to apply to the rechargeable battery based on the determined corresponding battery capacity such that the battery achieves a pre-determined charge that is reached within a charging period of time of 15 minutes or less, and applying a charging current having substantially about the determined current level to the battery.

Embodiments may include one or more of the following.

Determining the corresponding battery capacity may includes applying a test current to an identification resistor of the rechargeable battery, the identification resistor representative of the corresponding battery capacity, and measuring an identifying voltage drop at the identification resistor.

Determining the charging current may include retrieving from a lookup table a value corresponding to the charging current level to apply to the rechargeable battery based on the identifying voltage drop.

Determining the charging current may include computing a resistance value based on the measured identifying voltage drop and the test current, and selecting from a lookup table the charging current level to be applied to the rechargeable battery based on the computed resistance value.

The method may further include determining a temperature of the rechargeable battery, and adjusting the charging current based on the determined temperature.

The method may further include terminating the charging current after a period of charging time substantially equal to the charging period of time has elapsed.

The pre-determined charge of the battery may be at least 90% of the battery capacity of the battery, and the charging period of time may be approximately 5 minutes.

Applying the charging current includes applying a charging current to the rechargeable battery through a first set of terminals of a charger device, the first set of terminals configured to apply currents. The method may further include monitoring the voltage at terminals of the rechargeable battery through a second set of sensing terminals of the charger device, the second set of terminals configured to measure voltages.

In another aspect, a method for charging a rechargeable battery having at least one rechargeable electrochemical cell is discloses. The method includes applying a charging current to the rechargeable battery through a first set of charging terminals of a charger device, the first set of terminals configured to apply currents, and monitoring the voltage at terminals of the rechargeable battery through a second set of sensing terminals of the charger device, the second set of terminals configured to measure voltages.

Like the first method aspect above, embodiments of the other method may include any feature corresponding to any of the features as set forth above for the first method aspect

In a further aspect, disclosed, is a charger device configured to charge a rechargeable battery having at least one rechargeable electrochemical cell, the rechargeable battery including a battery identification mechanism configured to communicate identification information representative of a corresponding battery capacity associated with the rechargeable battery. The device includes a charging compartment configured to receive the rechargeable battery, the charging compartment including charging terminals configured to be coupled to respective battery terminals of the rechargeable battery, and a battery identification read mechanism configured to communicate with the battery identification mechanism of the rechargeable battery, and to receive the identification information. The device further includes a controller configured to determine the corresponding battery capacity based on the communicated identification information of the rechargeable battery, determine a charging current level to be applied to the rechargeable battery based on the determined corresponding battery capacity such that the battery achieves a pre-determined charge that is reached within a charging period of time of 15 minutes or less, and apply a charging current having substantially about the determined current level to the rechargeable battery.

like the method aspects, embodiments of the device may include any feature corresponding to any of the features as set forth above for the methods, as well as the following features.

The device may include the rechargeable battery.

In yet another aspect, a charger device configured to charge a rechargeable battery having at least one rechargeable electrochemical cell is disclosed. The device includes a charging compartment configured to receive the rechargeable battery, the charging compartment including a first set of charging terminals configured to apply electric currents to respective terminals of the rechargeable battery, and a second set of sensing terminals configured to measure voltages of the rechargeable battery. The device further includes a controller configured to apply a charging current to the rechargeable battery through the first set of charging terminals, and monitor the voltage between terminals of the rechargeable cells through the second set of sensing terminals.

Embodiments of the device may include any feature corresponding to any of the features as set forth above for the methods and device.

In yet a further aspect, a charger apparatus is disclosed. The apparatus includes a rechargeable battery having at least one rechargeable electrochemical cell, the rechargeable battery having a battery identification mechanism configured to communicate identification information representative of a corresponding battery capacity associated with the rechargeable battery. The apparatus further includes a charging compartment configured to receive the rechargeable battery, the charging compartment including charging terminals configured to be coupled to respective terminals of the rechargeable battery, and a battery identification read mechanism configured to communicate with the battery identification mechanism of the rechargeable battery, and to receive the identification information. The apparatus also includes a controller configured to determine the corresponding battery capacity based on the identification information of the rechargeable battery, determine a charging current level to be applied to the rechargeable battery based on the determined corresponding battery capacity such that the battery achieves a pre-determined charge that is reached within a charging period of time of 15 minutes or less, and apply a charging current having substantially about the determined current level to the battery.

Embodiments of the apparatus may include any feature corresponding to any of the features as set forth above for the methods and devices.

In an additional aspect, a docking station system is disclosed. The docking system includes a charging compartment configured to receive a battery-operable device having at least one rechargeable battery, the charging compartment including; connections to connect to respective connections of the battery-operable device, and an identification read mechanism configured to communicate with an identification mechanism of the battery-operable device, the identification mechanism configured to communicate identification information representative of a battery capacity associated with the at least one rechargeable battery. The docking station system further includes a controller configured to determine the corresponding battery capacity based on the communicated identification information, and determine a charging current level to be applied to the at least one rechargeable battery of the battery-operable device based on the determined corresponding battery capacity such that the at least one rechargeable battery achieves a pro-determined charge that is reached within a charging period of time of 15 minutes or less.

Embodiments of the docking station system may include any feature corresponding to any of the features as set forth above for the methods, devices and apparatus, as well as the following features.

The system may further includes the battery-operable device. The battery-operable device includes, for example, one of a mobile phone, a Personal Digital Assistant (PDA), a digital camera, an audio device and/or a multimedia device.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an exemplary embodiment of a charger apparatus that includes a charger and a battery.

FIG. 2 is a block-diagram of an exemplary embodiment of the charger shown in FIG. 1.

FIG. 3 is a circuit schematic of an exemplary circuit of the charger of FIG 2.

FIG. 4 is an exemplary embodiment of an AC/DC switcher.

FIG. 5 is a flow diagram of an exemplary embodiment of a charging procedure.

FIG. 6 is a view of an exemplary embodiment of a docking station to receive a battery-operable device.

### DETAILED DESCRIPTION

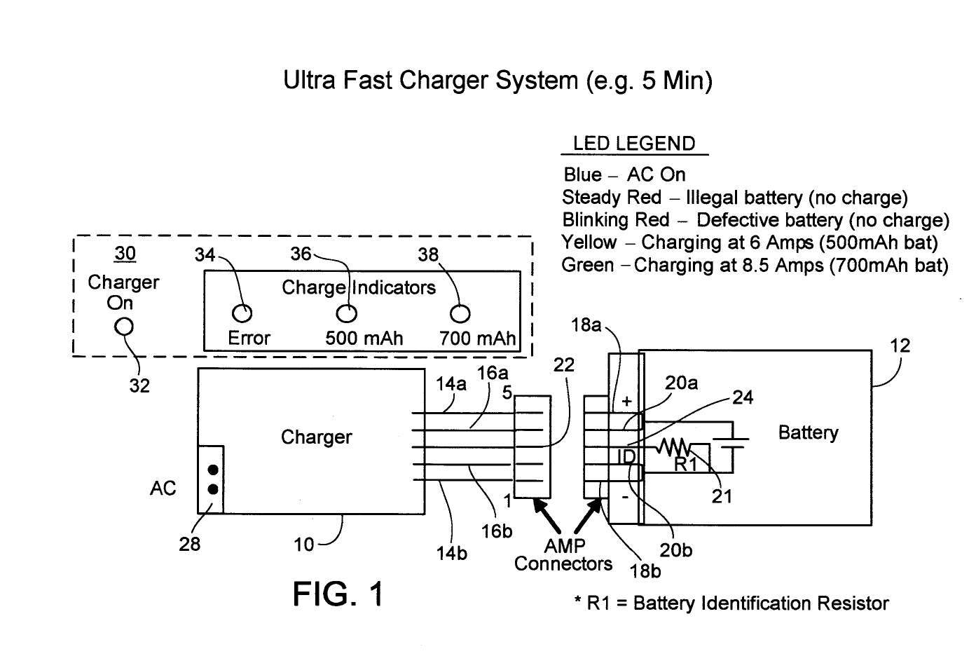

FIG. 1 shows a charger 10 configured to charge a battery 12 having at least one electrochemical cell. The battery 12 can be a secondary cell (or battery) or a primary cell Primary electrochemical cells are meant to be discharged, e.g., to exhaustion, only once, and then discarded. Primary cells are not intended to be recharged. Primary cells are described, for example, in David Linden, Handbook of Batteries (McGraw-Hill, 2d ed, 1995). Secondary electrochemical cells can be recharged for many times, e.g., more than fifty times, more than a hundred times, or more. In some cases, secondary cells can include relatively robust separators. such as those having many layers and/or that are relatively thick. Secondary cells can also he designed to accommodate for changes, such as swelling, that can occur in the cells. Secondary cells are described, e.g., in Falk & Salkind, “Alkaline Storage Batteries”, John Wiley & Sons, Inc. 1969; U.S. Pat. No. 345,124; and French Patent No. 164,681, all hereby incorporated by reference. In the embodiments described herein, the battery 12 is a secondary, or rechargeable, battery.

in some embodiments, the rechargeable battery 12 includes Li-ion cells having graphitic anode material or lithium titanate anode, material, and lithiated-iron-phosphate cathode materials adapted to enable fast recharge of rechargeable batteries based on such materials. The charger 10 may further be configured to charge different types of batteries, including, for example, cylindrical batteries, prismatic batteries, button-cell batteries, and so forth.

The battery 12 is received within a charging compartment of the charger 10 such that charging terminals 14a and 14b electrically and mechanically couple to terminals 18a and 18b, respectively, of the battery 12, and sensing terminals 16a and 16b electrically and mechanically couple to the sensing terminals 20a and 20, respectively, of the battery 12. In some embodiments, the terminals 18a, 18b, 20a and 20 are pins that are adapted to be connected in a mating configuration with respective terminals 14a, 14b, 16a and 16b located within the charging compartment of the charger 10. The charger 10 determines an appropriate charging current to be applied to the battery 12 and applies that charging current through terminals 14a and 14b to the battery 12 via terminals 18 and 18 of the battery 12. A voltage sensor electrically coupled to the terminals 16a and 16b, measures the voltage at terminals 20 and 20b (which corresponds to the voltage at the terminals 18a and 18b of the battery 12.) Based on the measured voltage, the charger 10 makes necessary adjustments to the charging voltage and/or current applied to the battery 12 so that the charger 10 can complete the charging operation of the battery 12 in accordance with the particular charging profile for the battery 12 (e.g., achieve 80-90% charge capacity in less than 15 minutes.) The charger 10 may also include, in some embodiments, one or more current sensors that are connected to the charging terminals 14a and 14b of the charger 10. Although FIG. 1 shows a single battery 12, the charger 10 may be adapted to receive and charge additional rechargeable batteries. Further, the charger 10 may be configured to receive and charge different battery types including cylindrical batteries, prismatic batteries, coin or button batteries, etc.

The charger 10 is configured to charge batteries with different capacities. The charger determines the capacity of the rechargeable battery 12 that is connected to the charger 10. Based on the determined battery capacity, the charger 10 determines a current level to be applied to the rechargeable battery 12 such that a pre-determined charge (e.g., 90% capacity) for the battery 12 is reached within approximately 5 minutes for example. To achieve this charging performance, charging currents corresponding to approximately 10-15 C are required (where a 1 C is a charge rate that corresponds to a charging current that would result in particular rechargeable battery becoming charged in 1 hour, whereas a charge rate of 12 C corresponds to a current level that would charge a particular battery in 5 minutes (i.e., 1/12^{th} of an hour.)

Because the charger is configured to charge batteries with different capacities, and hence, the capacity of the battery 12 may be one of multiple possible capacities, different level charging currents are applied to according to the capacity of the battery 12. Typically, the capacity of the battery is in a range of 50 mAh to 3 Ah, where “Ah” is the unit of battery capacity Ampere-hour, Other capacities can be accommodated. Thus, for example, to charge a 500 mAh capacity battery to greater than 90% of full capacity at a charge rate of 12 C (i.e., in approximately five minutes), a charging current of approximately 6 Ah is required to (i.e., 6 Ah* 1/12 hours=500 mAh.) On the other hand, to charge a 700 mAh battery with a charge rate of 12 C, a charging current of approximately 8.5 A is required

The charger 10 is further configured to control the charging process, including regulating the voltage and/or current applied to the battery 12, to ensure that (a) the battery 12 is charged to its pre-determined charge level within the given time period, (b) the battery's voltage does not exceed a pre-determined upper voltage limit, and/or (c) the voltage increase rate (i.e., the rate at which the voltage at the charging terminals of the battery 12 increase as the charging operation progresses) conforms to specified charging profile (e.g., it increase at a particular rate for the first 1 minute of the charging operation.)

Control of the charging process requires monitoring of the voltage at the terminals of the battery 12. Accordingly, to perform required adjustments to the voltage and/or current applied to the battery 12, accurate measurements of the voltage at the terminals of the battery 12 are needed. However, because a charger's charging terminals have a non-negligible resistance, in circumstances where voltage sensing is coupled to the charging terminals of the charger, the voltage drop measured would include the voltage drop at the charging terminals of the charger 10 resulting from the resistance of the charger's charging terminals. Consequently, chargers that include voltage sensing coupled directly to the charger's charging terminals may result in some degree of measurement error.

Therefore, to reduce the effect of voltage measurement inaccuracies, the charger 10 uses one set of terminals (namely, terminals 14a and 14b) to apply the charging current, and a separate dedicated set of terminals (namely, terminals 16a and 16b) to measure the battery's voltage. The two charging terminals 14a and 14b of the charger 10 are adapted to be coupled to corresponding charging terminals 18a and 18b of the battery 12, and the two separate sensing terminals 16a and 16b of the charger 10 are adapted to be electrically coupled to corresponding dedicated sensing terminals 20a and 20b of the battery 12. Such a 4-terminal configuration, like the one shown in FIG. 1 is sometimes referred to as Kelvin configuration, or Kelvin connection. The sensing terminals 16a and 16b of the charger 10 are electrically isolated from the charging terminals 14a and 14b of the charger 10 to thus reduce the voltage measurement error that may otherwise result were the two sets of terminals are coupled to each other. Use of separate charging terminals and separate sensing terminals enables the charging, process to be regulated accurately. The terminal 18a is in electrical communication with sensing terminal 20a, and likewise terminal 18b is in electrical communication with the sensing terminal 20b, and thus the voltage feedback corresponds to the voltage at the charging terminals of the battery 12.

In some embodiments, an additional terminal or pin in the charger's charging compartment can be used to enable determination of the battery capacity, and/or other pertinent information regarding the battery 12. Specifically, the charger 10 includes a battery identification read mechanism that includes an ID sensing terminal 22 that is configured to be mechanically and electrically coupled to an identification mechanism of the battery 12 that is configured to provide the charger 10 with identification information representative of the battery's capacity, type, model, and/or other data germane to the charging operation to be performed on the rechargeable battery 12. The charger 10 is configured to communicate with the battery identification mechanism and to receive the identification information. Based on the identification information received from the battery 12, the charger 10 determines the charging current to apply to the battery 12.

One such example of a battery identification mechanism is a battery ID resistor 26 that has a resistance value representative of the corresponding battery capacity, type, and/or model of the battery 12. The ID resistor 26 may be disposed in the interior of the casing of the battery 12, or it may be disposed on the exterior of the battery 12. In the example shown in FIG. 1, the ID resistor 26 is electrically coupled to a dedicated battery ID terminal 24 which is adapted to be mechanically and electrically coupled to the terminal 22 of the charger 10.

The ID resistor 26 is electrically coupled to the power terminal 18b and the sensing terminal 20b of the battery 10. Accordingly, upon applying a current or voltage to the ID terminal 24 of the battery 12 from the terminal 22 of the charger 10, a closed electrical path between the terminals 18b, and 24 of the battery 12 is formed, resulting in the flow of electrical current through the ID resistor 26. To obtain information representative of the battery's capacity and/or identity, a pre-determined test current, Iₜₑₛₜ, is applied by the Charger 10 to the ID resistor 26 via the ID terminal 24. A voltage drop V_{R1} across the ID resistor 26 is measured using a voltage sensor of the charger 10 coupled to the terminal 22. The measured voltage drop at the ID resistor 26 is communicated to the charger 10, which uses the measured voltage to compute the resistance of the ID resistor 26 according to R1=V_{R1}/Iₜₑₛₜ.

The computed resistance R1 corresponding to the ID resistor 26 is used to access a lookup table that holds for each of a plurality of different resistance values associated data. Such data may include the respective battery capacities associated with the resistance values, permissible charge current values to apply to the battery, and/or other information that may be germane to the charging process. Alternatively, the measured voltage V_{R1} may be used to access the lookup table.

In some embodiments, the ID resistor 26 is a thermistor whose resistance varies with changing temperature. Such an ID thermistor can thus be used to both identify the type of battery to be charged and to monitor the battery's temperature. The charger 10 determines the temperature of the battery based on the variations in the resistance of the thermistor. For example, determination of the temperature of the battery is performed by measuring the voltage at the thermistor resulting from applying a current of some pre-determined level, and matching the measured voltage, or the resistance computed based on the measured voltage and applied current, to a lookup table that relates, for a particular battery capacity or type, the measured value to a corresponding temperature. When the temperature of the battery reaches a level deemed to be unsafe, the charger 10, based on the determined temperature, either lowers or terminates the charging current to cause the battery's temperature to decrease. In some embodiments, the charger 10 may be implemented without thermal control and/or thermal monitoring mechanisms, and thus, in such embodiments, operation of determining the temperatures of the battery and/or the charger, and responding thereto, are not performed.

Other types of battery identification mechanisms may be employed. Suitable battery identification mechanisms may include Radio Frequency Identification (RFID) mechanisms in which in response to an activation signal (e.g., a radio signal), an RFID device communicates to the charger 10 an electrical signal representative of the battery's capacity, type, state of the battery's charge/health, etc. Other suitable identification mechanisms include mechanisms that implement serial communication techniques to identify the battery, e.g., the Smart Battery SMBus standards to cause identification data representative of the battery's capacity and/or type to be communicated to the charger 10 via a serial data communication interface. In some embodiments, determination of the charging current may be performed by measuring at least one of the battery's electric characteristics indicative of the capacity and/or type of battery (e.g., the battery's DC charging resistance.) A detailed description of an exemplary charger device that adaptively determines the charging current based on measured characteristics of the battery is provided in the concurrently filed patent application entitled “Adaptive Charger Device and Method”, the content of which is hereby incorporated by reference in its entirety.

As further shown in FIG. 1, the charger 10 includes a user interface 30. The user interface 30 includes output devices, such as LED's, that provide status information to a user regarding the charger 10 and/or battery 12 connected thereto. The user interface 30 includes, for example, a “Charger On” blue-colored LED 32 that becomes illuminated when the charger is in operation and is connected to an external power supply, such as an AC power supply connected to the charger 10 via an AC power port 28. The user interface includes, e.g., a red-colored LED 34 that is activated to produce a steady red illumination when an battery that cannot be accommodated by the charger 10 is inserted into the charging compartment. Such a battery may include, for example, a disposable non-rechargeable battery, or a rechargeable battery whose ID resistor 26 has a value representative of a capacity or of a battery type that the charger 10 is not configured to handle. The red LED 34 may also be activated to produce a blinking red illumination when a defective battery is inserted into the charging compartment. For example, batteries whose initial voltage level is below, e.g., 2V, may be damaged, and thus the charger 10 may not commence the charging operation until the suspected damaged battery is removed. The red LED may also be illuminated upon the detection of a fault, condition that could adversely affect the operation of the charger and/or damage the charger or battery. Such fault conditions include the detection of abnormal voltage levels at the battery's terminals, overheating conditions of the battery and/or the charger (e.g., if temperatures exceeding 60° C. are detected), etc. A detailed description of exemplary procedures to detect and respond to fault conditions that transpire in the course of charging batteries is provided in the concurrently filed patent application entitled “Fast Battery Charger Device and Method”, the content of which is hereby incorporated by reference in its entirety.

The user interface 30 also includes a yellow LED 36 that is illuminated when the charger is charging the battery 12 with a current of, for example, 6 A. Such a charging current could be indicative that the battery placed inside the charging compartment of the charger 10 has a capacity of 500 mAh, which at a charging current of 6 A would complete the charging operation in approximately 5 minutes. The user interface 30 also includes a green LED 38 that is illuminated when the charger is charging the battery 12 with a current of for example, 8.5 A. Such a charge current could be indicative that the battery placed inside the charging compartment of the charger 10 has a capacity of 700 mAh, which at a charging current of 8.5 A would also complete the charging operation in approximately 5 minutes. The user interface 30 could include additional LED's that could each correspond to different conditions (e.g., different fault conditions), different battery capacities, etc. Further, the color and/or illumination scheme described herein could be modified so that different colors could correspond to different battery capacities or to different conditions.

The user interface 30 may include a display device configured to provide output information to the user. For example, in situations in which a suspected damaged battery, or an illegal battery, has been placed in the charging compartment, the user interface would cause a message of “Defective Battery”, or “Illegal Battery”, to be displayed.

The user interface 30 may also include a user-input section (not shown) that could include switches, buttons and/or knobs through which a user may indicate, for example, the charging period, and/or other types of parameters pertaining to the charging process. Thus, if the user desires to charge the battery at a rate other than one that would result in the battery becoming at least 90% charged within approximately 5 minutes, the user may so specify through the user-input section of the interface 30. Based on the identity of the battery (which may be determined through an identification mechanism such as an ID resistor, by specifying the battery type and/or capacity through the user-input section, or through other battery determination schemes), the charger could access a lookup table that indexes suitable charging current values based on the charging period and the battery identity and/or capacity. In some embodiments, computation techniques may be used to determine the appropriate charging current. The user-input section of the user interface 30 may also include an input element (e.g., switch) to enable or disable the charger 10.

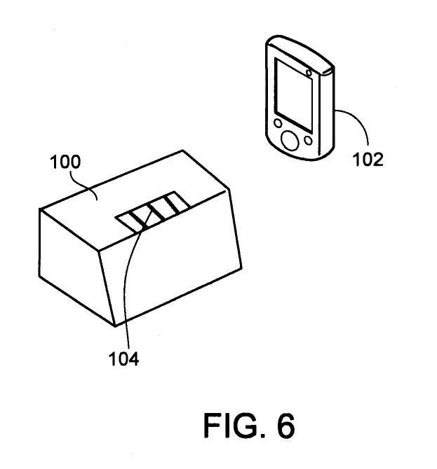

In some embodiments, the charger 10 may be adapted to charge batteries placed in a socket or a device (e.g., a cell phone in which a rechargeable battery is left inside the cell phone during charging operations.) In such embodiments, a battery embedded in a device is electrically coupled, to, for example, a 5-pin terminal disposed on the device case. Alternatively, such a battery may be coupled to female type connectors to avoid short-circuiting of the battery. The charger could, under these circumstances, include a docking station, powered by AC or CLA (12V car cigarette light adapter), and structured to receive the device having the embedded rechargeable battery. The device is placed in the docking station in a mating configuration. The docking station initiates an ID check, and applies a corresponding charging current, determined based on the battery capacity (as determined by the ID check), to charge the battery of the device in approximately 5 minutes. Referring to FIG. 6, an exemplary docking station 100 and a battery-operable device, such as a personal digital assistant (PDA) 102, configured to be received in a mating configuration with the docking station 100, are shown. The docking station includes connections 104 that are coupled to respective connections (also not shown) disposed on the battery-operable device (in this case, the PDA 102.) In some embodiments, the battery-operable device includes one of a mobile phone, a Personal Digital Assistant (PDA), a digital camera, an audio device and a multimedia device. In some embodiments, the charger 10 may cause the charging current to ramp slowly to prevent arcing of the charger's connector.

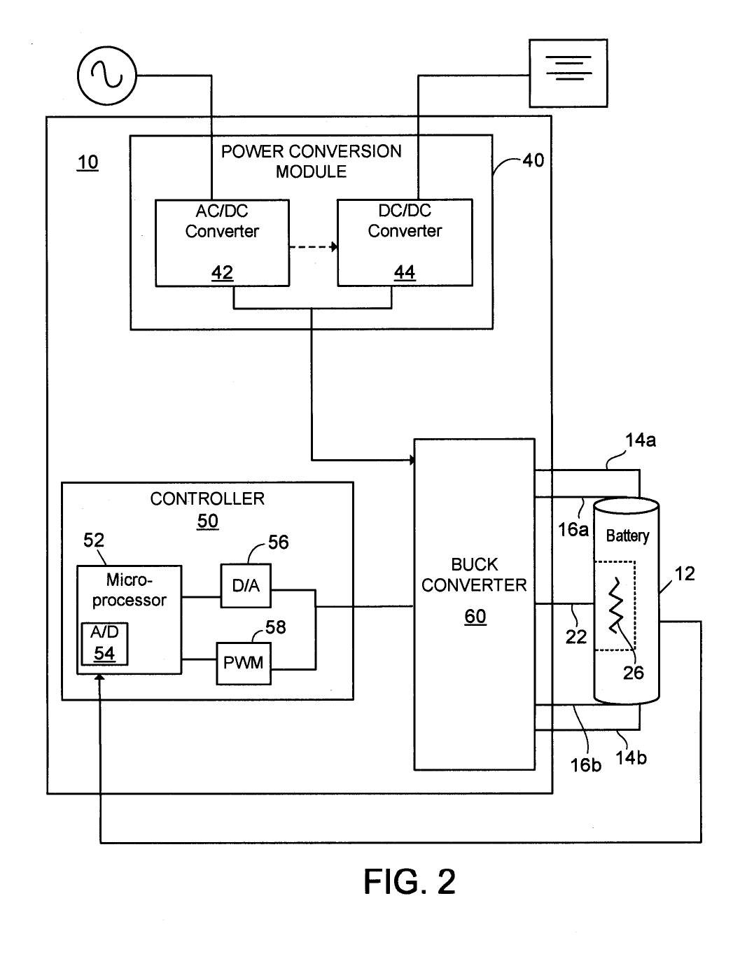

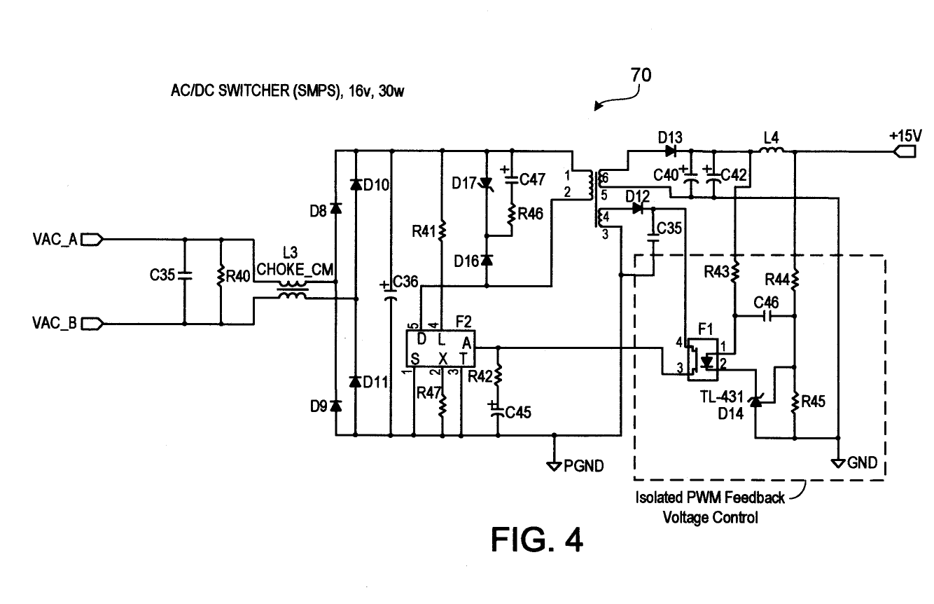

FIG. 2 depicts details of an exemplary embodiment of the charger 10. The charger 10 includes a power conversion module 40 that includes an AC-DC converter 42 that is electrically coupled to an AC power source, external to the charger, such as a source providing power at a rating of 85V-265V and 50 Hz-60 Hz, and converts the AC power to a low D.C. voltage (e.g., 5-24V) and e.g., feeds this low D.C. voltage to, e.g., a DC-DC converter 44 to provide a level suitable for charging rechargeable batteries (e.g., DC voltages at levels of approximately between 3.7-4.2V for the Li-Ion cells mentioned above. Other types of cells may have different voltage levels.) The AC-DC converter 42 is implemented as an isolated AC/DC switcher configured to accept input power at a first, alternating voltage and transform it to a lower constant DC voltage. An exemplary embodiment of an AC/DC switcher 70 is shown in FIG. 4. The AC-DC converter 42 includes a galvanic isolation between the AC input line and the DC output to prevent input AC current from reaching the DC output section of the AC-DC converter 42.

The AC-DC converter 42 may also include a feedback mechanism (not shown) to regulate the DC output voltage of the converter 42 so that a substantially constant voltage level is provided at the converter's output.

In some embodiments, the DC-DC converter 44 is incorporated into the power conversion module 40 to convert an external DC power source, such as a car's DC power supply, to a DC power level suitable for charging rechargeable batteries. For example, a car's DC power supply supplies approximately 11.5-14.3V DC power, and the DC-DC converter 44 converts that power level to a suitable power level. Other power conversion configurations may also be used.

In some embodiments, the power conversion module 40 is disposed within the housing of the charger 10. Alternatively, the power conversion module 40 may be disposed in a separate housing that is adapted to be electrically connected to the charger 10.

The charger 10 includes a controller 50 that determines the charging current to apply to the battery 12 and causes the determined charging current to be applied the battery 12. The controller 50 also causes the charging current to be terminated after a specified or pre-determined time period has elapsed. The controller 50 may also configured to cause the charging current to terminate once a pre-determined battery voltage or charge has been reached. As described herein, determination of the charging current may be performed by identifying the capacity and/or type of the battery(s) placed in the charging compartment of the charger 10 using, for example, an identification mechanism that communicates data representative of the capacity and/or type of the battery 12.

The controller 50 includes a processor device 52 configured to control the charging operations performed on the battery 12. The processor device 52 may be any type of computing and/or processing device, such as a PIC18F1320 microcontroller from Microchip Technology Inc. The processor device 52 used in the implementation of the controller 50 includes volatile and/or non-volatile memory elements configured to store software containing computer instructions to enable general operations of the processor-based device, as well as implementation programs to perform charging operations on the battery 12 connected to the charger, including such charging operations that achieve at least 90% charge capacity in approximately 5 minutes, and operations that identify or otherwise determine the capacity and/or type of the battery 12

The processor 52 includes an analog-to-digital (A/D) converter 54 with multiple analog and digital input and output lines. The A/D converter 54 is configured to receive signals from sensors coupled to the battery 12, such as the voltage sensor coupled to the sensing terminals 16a and 16b of the charger 10, to facilitate regulating and controlling the charging operation. In some embodiments, the controller 50 may also include a digital signal processor (DSP) to perform some or all of the processing functions of the control device.

The controller 50 also includes a digital-to-analog (D/A) converter device 56, and/or a pulse-width modulator (PWM), 58 that receives digital signals generated by the processor device 52 and generates in response electrical signals that regulate switching circuitry, such as a buck converter 60, of the charger 10.

In some embodiments, the charger 10 may include an automatic load/unload mechanism (not shown) to automatically displace batteries and/or charging compartments, from a first entry position on the charger 10 to a second position such that the terminals (charging and/or sensing) of the batteries are in electrical communication with the respective terminals of the charger 10. At the end of the charging operation, the charger 10 would cause the automatic load/unload mechanism to unload the batteries, thus displacing the batteries front their second position to their entry position as disclosed in concurrently filed patent application entitled “Battery Charger with Mechanism to Automatically Load and Unload Batteries” the content of which is hereby incorporated by reference in its entirety.

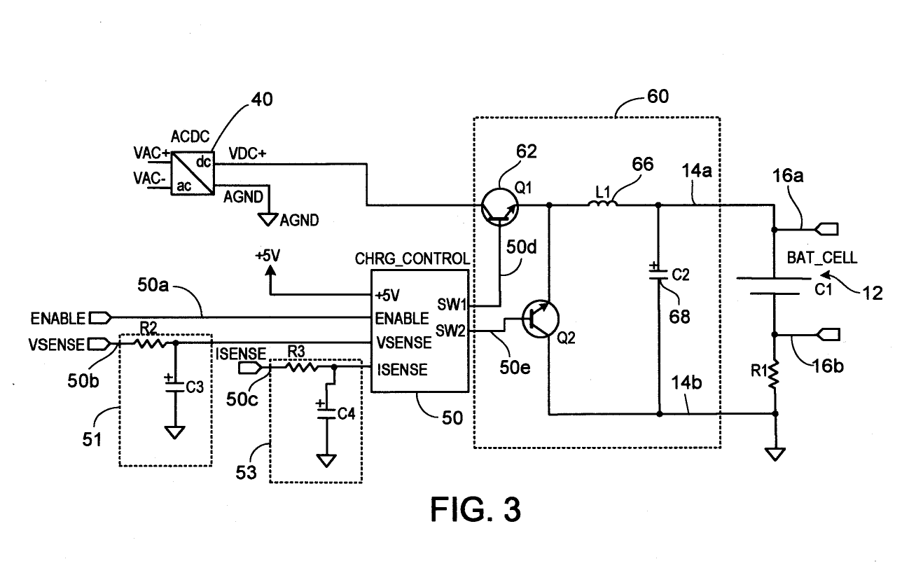

FIG. 3 shows the buck converter 60 including two, e.g., Bi-Polar Junction Transistors (BJT's) 62 and 64 and an inductor 66 that stores energy when the power conversion module 40 is in electrical communication with the buck converter 60, and which discharges that energy as current during periods that the power conversion module 40 is electrically isolated from the buck converter 60. The buck converter 60 shown in FIG. 3 also includes a capacitor 68 that is also used as an energy storage element. The inductor 66 and the capacitor 68 also act as output filters to reduce the switching current and voltage ripples at the output of the buck converter 60.

Power transmitted to the battery 12 from the power conversion module 40 is regulated by controlling the voltage level applied to the bases of the transistors 62 and 64. To cause power from the power conversion module 40 to be applied to the terminals 18a and 18b of the battery 12, an actuating electric signal from a terminal 50d (marked SW1) of the controller 50 is applied to the base of the transistor 62, resulting in the flow of current from the power conversion module 40 to the transistor 62 and to the battery 12.

When the actuating signal applied to the base of the transistor 62 is withdrawn, current-flow from the power conversion module 40 stops and the inductor 66 and/or the capacitor 68 supply current from the energy stored in them. During the off-period of the transistor 62, a second actuating signal is applied by the terminal 50e (marked SW2) of the controller 50 to the base of a transistor 64 to enable current flow (using the energy that was stored in the inductor 66 and/or the capacitor 68 during the on-period of the transistor 62) through the battery 12. In some embodiments, a rectifying diode is utilized in place of transistor 64, the diode providing similar functionality as the transistor 64.

The transistor's on-period, or duty cycle, is initially ramped up from 0% duty cycle, while the controller or feedback loop measures the output current and voltage. Once the determined charging current to he applied to the battery 12 is reached, the feedback control loop manages the transistor duty cycle using a closed loop linear feedback scheme, e.g., using a proportional-integral-differential, or PID, mechanism. A similar control mechanism may be used to control the transistor's duty cycle once the charger voltage output, or battery terminal voltage, reaches the crossover voltage.

Thus, the current provided by the power conversion module 40 during the on-period of the transistor 62, and the current provided by the inductor 66 and/or the capacitor 68 during the off-periods of the transistor 62 should result in an effective current substantially equal to the required charging current.

In some embodiments, controller 50 periodically receives (e.g., every 0.1 second) a measurement of the current flowing through the battery 12 as measured, for example, by a current sensor that communicates the measured value via a terminal 50c (marked ISENSE) of the controller 50. Based on this received measured current, the controller 50 adjusts the duty cycle to cause an adjustment to the current flowing through the battery 12 so that current converges to a value substantially equal to the charging current level. The buck converter 60 is thus configured to operate with an adjustable duty cycle that results in adjustable current levels being supplied to the battery 12.

in addition to the voltage sensor and/or the current sensor, the charger 10 may include other sensors configured to measure other attributes of either the battery 12 and/or the charger 10. For example, the charger 10 may include temperature sensors coupled to the battery 12 and/or the circuit board on which the controller 50 is arranged. As noted, in circumstances in which the battery 12 includes a thermistor to serve as the ID resistor 26, the thermistor is used to measure the temperature of the battery and determine if the battery 12 may be overheating. The charger 10 may also include a temperature sensor (e.g., a thermistor-based sensor or thermometer) to measure the temperature of the circuit board on which the modules of the controller 50 are arranged to enable the controller 50 to take remedial or preemptive actions in the event the board is overheating (e.g., the temperature of the board exceeds 60° C.) Remedial and/or preemptive actions to counter unsafe operating conditions include terminating the charging operation, or reducing the charging current to cause the temperature of the battery 12 and/or the charger 10 to decrease.

In some embodiments, the received measured signals are processed using analog logic processing elements (not shown) such as dedicated charge controller devices that may include, for example, threshold comparators, to determine the level of the voltage and current level measured by the voltage and/or current sensors. The charger 10 may also include a signal conditioning blocks, such as filters 51 and 53, for performing signal filtering and processing on analog and/or digital input signals to prevent incorrect measurements (e.g., incorrect measurements of voltages, temperatures, etc.) that may be caused by extraneous factors, such as circuit level noise.

The controller 50 is further configured to maintain the voltage at the terminals of the battery 12 at about a substantially constant pre-determined upper voltage limit (also called the crossover voltage) once that upper limit is reached. While the battery 12 is being charged with a current substantially equal to the charging current, the voltage at terminals of the battery increases. To ensure that the voltage at the battery's terminals does not exceed the pre-determined upper voltage limit (so that the battery does not overheat, or that the battery's operation or expected life is not otherwise adversely affected), the voltage at the terminals of the battery 12 is periodically measured (e.g., every 0.1 seconds) using the voltage sensor to determine when the pre-determined upper voltage limit has been reached. The measured voltage is communicated to the controller 50 via a terminal 50b (marked VSENSE.) When the voltage at the terminals of the battery 12 has reached the pre-determined upper voltage limit, the current/voltage regulating circuit is controlled to cause a substantially constant voltage at the terminals of the battery 12.

In some embodiments, the controller 50 is configured to monitor the voltage increase rate by periodically measuring the voltage at the terminals of the battery 12, and adjust the charging current applied to the battery 12 such that the pre-determined upper voltage limit is reached within some specified voltage rise period of time. Based on the measured voltage increase rate, the charging current level is adjusted to increase or decrease the charging current such that the pre-determined upper voltage limit is reached within the specified voltage rise period. Adjustment of the charging current level maybe performed, for example, in accordance with a predictor-corrector technique that uses a Kalman filter. Other approaches for determining adjustments to the current to achieve the predetermined upper voltage limit may be used.

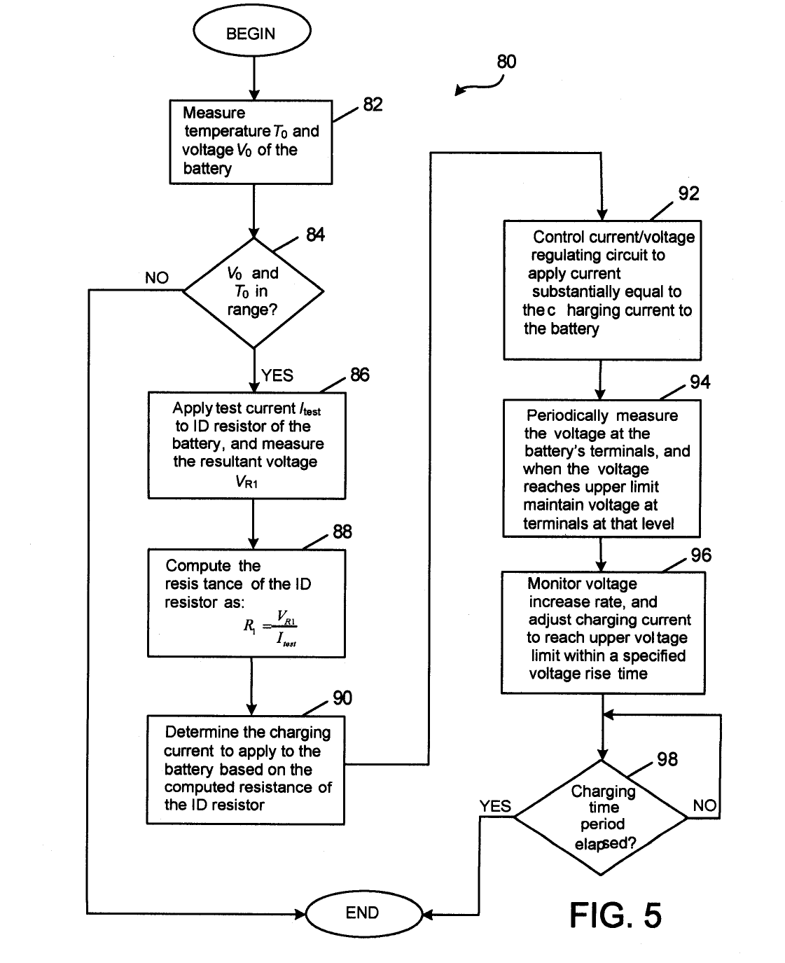

FIG. 5 depicts an exemplary charging procedure 80 to recharge the rechargeable battery 12 inserted into the charging compartment of the charger 10. When placed inside the charging compartment, the charging terminals 34a and 14 of the charger 10 are electrically coupled to the charging terminals 18a and 18b of the battery 12, and the sensing terminals 16a and 16b of the charger 10 are electrically coupled to the charging terminals 20a and 20b of the battery 12. As explained herein, measuring the battery's voltage and/or current through dedicated sensing terminals of the charger 10 rather than through the charging terminals of the charger 10 reduces the occurrence of measuring errors, thus resulting in more accurate regulation of the charging procedure performed by the charger 10.

Optionally, the charger 10 determines prior to commencing the charging operation whether any fault conditions exist. Thus, the charger 10 measures 82 the temperature and voltage of the battery 12. The charger 10 determines 84, whether the initially measured temperature T₀ and voltage V₀ are within predetermined ranges (e.g., that V₀ is between 2-3.8V, and that the temperature T₀ is below 60° C.) In circumstances in which it is determined that the measured temperature and/or voltage are not within the predetermined acceptable ranges, thus rendering a charging operation under present conditions to be unsafe, the charger does not proceed with the charging operation, and the procedure 80 terminates.

If it is determined that the measured temperature T₀ and voltage V₀ are within the predetermined respective limits, the charger 10 applies 86 a test current Iₜₑₛₜ of a pre-determined value to the ID resistor 26 of the battery 12. The resultant voltage drop V_{R1} at the ID resistor 26 is measured using a voltage sensor coupled to the terminal 22 of the charger 10.

Having measured the voltages V_{R1}, the resistance of the ID resistor 26 is computed 88 as:

$${R}_{1} = \frac{{V}_{R 0}}{{I}_{test}}$$

The computed resistance is representative of the battery 12 connected to the charger 10 and thus is representative of the capacity of the battery. Accordingly, the computed value of resistance is used to determine 90 the charging current to apply to the battery 12. The processor 50 accesses the lookup table which indexes suitable charging currents corresponding to the capacity associated with the computed resistance values. In circumstances in which the determined capacity is associated with multiple charging current entries, a user's desired charging period (specified, for example, using the input section of the user interface 30) may be used to select the appropriate entry associated with the battery capacity and/or type identified from, the computed resistance of the ID resistor 26 battery characteristic. Generally, in embodiments in which s charging period of 5 minutes is to be used, the charging current value that would charge the battery 12, having the determined battery capacity, in 5 minutes is retrieved from the lookup table. For example, if it was determined, based on the computed resistance of the ID resistor 26, that the connected battery has a capacity of 500 mAh, a value indicative of a charging current of 6 A is be retrieved from the lookup table.

Having determined the charging current to be applied to battery 12, a current/voltage regulating circuit, such as the buck converter 60 shown in FIG. 3, is controlled 92 to cause a voltage from the power conversion module 40 to provide a constant current to the rechargeable battery 12. As explained, the charging current level value computed at 90 is processed to generate a duty cycle signal to cause current substantially equal to the charging current to be applied to the battery 12. The controller's output signals are applied, for example, to the transistor 62 of the buck converter 60 to cause voltage from the power conversion module 40 to be applied to the battery 12. During the off-time of a particular duty cycle, the power conversion module 40 is cutoff from the battery 12, and the energy stored in the inductor 66 and/or capacitor 68 is discharged to the battery as a current. The combined current applied from the power conversion module 40, and the current discharged from the inductor 66 and/or the capacitor 68 result in an effective current substantially equal to the determined charging current.

While the battery 12 is charged with a substantially a constant current, the voltage at terminals of the battery increases. To ensure that the voltage at the battery's terminals does not exceed a pre-determined upper voltage limit, the voltage at the terminals of the battery 12 is periodically measured 94 (e.g., every 0.1 seconds) to determine when the pre-determined upper voltage limit has been reached. When the voltage at the terminals of the battery 12 has reached the pre-determined upper voltage limit, the current/voltage regulating circuit is controlled (e.g., through electrical actuation of the transistors 62 and 64) so that a constant voltage level is produced at the terminals of the battery 12.

Optionally, the voltage increase rate may be periodically measured, 96, to cause the pre-determined upper voltage limit to be reached within the specified voltage rise period of time. Based on the measured voltage increase rate, the charging current level is adjusted (with a corresponding adjustment of the actuating signal applied to the current/voltage regulating circuit) to increase or decease the charging current such that the pre-determined upper voltage limit is reached within the specified voltage rise period.

After a period of time substantially equal to the charging time period has elapsed, as determined 98, the charging current applied to the battery 12 is terminated (for example, by ceasing electrical actuation of the transistor 62 to cause power delivered from the power conversion module 40 to be terminated). The charging procedure is terminated at the expiration of a particular period of time after the pre-determined upper voltage limit of the battery 12 has been reached, or after some specified charge level of the battery 12 has been reached.

### Other Embodiments

A number of embodiments of the invention have been described. Nevertheless, it will be understood that various modifications may be made without departing from the spirit and scope of the invention. Accordingly, other embodiments are within the scope of the following claims.

What is claimed is:

1. A method for charging a rechargeable battery having at least one rechargeable electrochemical cell, the method comprising:
determining a corresponding battery capacity based on identification information received from the rechargeable battery;
determining a charging current level to apply to the rechargeable battery based on the determined corresponding battery capacity such that the battery achieves a pre-determined charge that is reached within a charging period of time of 15 minutes or less; and
applying a charging current having substantially about the determined current level to the battery.

2. The method of claim 1, wherein determining the corresponding battery capacity comprises:
applying a test current to an identification resistor of the rechargeable battery, the identification resistor representative of the corresponding battery capacity; and
measuring an identifying voltage drop at the identification resistor.

3. The method of claim 2, wherein determining the charging current comprises;
retrieving from a lookup table a value corresponding to the charging current level to apply to the rechargeable battery based on the identifying voltage drop.

4. The method of claim 2, wherein determining the charging current comprises:
computing a resistance value based on the measured identifying voltage drop and the test current; and
selecting from a lookup table the charging current level to be applied to the rechargeable battery based on the computed resistance value.

5. The method of claim 2, further comprising:
determining a temperature of the rechargeable battery; and
adjusting the charging current based on the determined temperature.

6. The method of claim 1 further comprising:
terminating the charging current after a period of charging time substantially equal to the charging period of time has elapsed.

7. The method of claim 1, wherein the pre-determined charge of the battery is at least 90% of the battery capacity of the battery, and wherein the charging period of time is approximately 5 minutes.

8. The method of claim 1, wherein applying the charging current includes applying a charging current to the rechargeable battery through a first set of terminals of a charger device, the first set of terminals configured to apply currents.

9. The method of claim 8, further comprising:
monitoring the voltage at terminals of the rechargeable battery through a second set of sensing terminals of the charger device, the second set of terminals configured to measure voltages.

10. A method for charging a rechargeable battery having at least one rechargeable electrochemical cell, the method comprising:
applying a charging current to the rechargeable battery through a first set of charging terminals of a charger device, the first set of terminals configured to apply currents; and
monitoring the voltage at terminals of the rechargeable battery through a second set of sensing terminals of the charger device, the second set of terminals configured to measure voltages.

11. The method of claim 10, further comprising:
receiving from an identification mechanism of the rechargeable battery an identification information representative of a corresponding battery capacity of the rechargeable battery;
determining the corresponding battery capacity for the rechargeable battery based on the received identification information; and
determining the charging current level based on the determined corresponding battery capacity such that the rechargeable battery achieves a pre-determined charge that is reached within a charging period of time of 15 minutes or less.

12. The method of claim 11, wherein determining the corresponding battery capacity comprises:
applying a test current to an identification resistor of the rechargeable battery, the identification resistor representative of the corresponding battery capacity; and
measuring an identifying voltage drop at the identification resistor.

13. The method of claim 11, wherein the pre-determined charge of the battery is at least 90% of the battery capacity of the battery, and wherein the charging period of time is approximately 5 minutes.

14. A charger device configured to charge a rechargeable battery having at least one rechargeable electrochemical cell, the rechargeable battery including a battery identification mechanism configured to communicate identification information representative of a corresponding battery capacity associated with the rechargeable battery, the device comprising:
a charging compartment configured to receive the rechargeable battery, the charging compartment including:
charging terminals configured to be coupled to respective battery terminals of the rechargeable battery, and
a battery identification read mechanism configured to communicate with the battery identification mechanism of the rechargeable battery, and to receive the identification information; and
a controller configured to:
determine the corresponding battery capacity based on the communicated identification information of the rechargeable battery;
determine a charging current level to be applied to the rechargeable battery based on the determined corresponding battery capacity such that the battery achieves a pre-determined charge that is reached within a charging period of time of 15 minutes or less; and
apply a charging current having substantially about the determined current level to the rechargeable battery.

15. The device of claim 14, wherein the battery identification read mechanism comprises:
an ID-sensing terminal configured to apply a test current to an identification resistor of the rechargeable battery, the identification resistor representative of the corresponding battery capacity; and
a voltage sensor configured to measure an identifying voltage drop at the identification resistor.

16. The device of claim 15, wherein the controller is configured to:
select from a lookup table stored on a memory module of the controller the charging current level to be applied to the rechargeable battery based on the measured identifying voltage drop.

17. The device of claim 15, wherein the controller is configured to:
compute a resistance value based on the measured identifying voltage drop and the sensing current; and
select from a lookup table stored on a memory module of the controller the charging current level to be applied to the rechargeable battery based on the computed resistance value.

18. The device of claim 15, wherein the identification resistor is a thermistor having a variable resistance based on a temperature of the rechargeable battery, and wherein the controller is further configured to:
determine the temperature of the rechargeable battery based on varying resistance of the thermistor; and
adjust the charging current based on the determined temperature.

19. The device of claim 14, wherein the controller is further configured to:
terminate the charging current after a period of time substantially equal to the charging period of time has elapsed.

20. The device of claim 14, wherein the pre-determined charge of the rechargeable battery is at least 90% of the battery capacity of the rechargeable battery, and wherein the charging period of time is approximately 5 minutes.

21. The device of claim 14, further comprising the rechargeable battery.

22. A charger device configured to charge a rechargeable battery having at least one rechargeable electrochemical cell, the device comprising:
a charging compartment configured to receive the rechargeable battery, the charging compartment including:
a first set of charging terminals configured to apply electric currents to respective terminals of the rechargeable battery, and
a second set of sensing terminals configured to measure voltages of the rechargeable battery;, and
a controller configured to:
apply a charging current to the rechargeable battery through the first set of charging terminals; and
monitor the voltage between terminals of the rechargeable cells through the second set of sensing terminals.

23. The device of claim 22, further comprising:
a battery identification read mechanism configured to communicate with a battery identification mechanism of the rechargeable battery, and to receive from an identification mechanism of the rechargeable battery identification information representative of a corresponding battery capacity;
wherein the controller is further configured to:
determine the corresponding battery capacity based on the received identification information of the rechargeable battery; and
determine the charging current level to be applied to the rechargeable battery based on the determined corresponding battery capacity such that the battery achieves a pre-determined charge that is reached within a charging period of time of 15 minutes or less.

24. The device of claim 23 wherein the battery identification read mechanism includes:
an ID-sensing terminal configured to apply a test current to an identification resistor of the rechargeable battery, the identification resistor representative of the corresponding battery capacity; and
a voltage sensor device configured to measure an identifying voltage drop at the identification resistor.

25. The device of claim 23, wherein the pre-determined charge of the rechargeable battery is at least 90% of the battery capacity of the rechargeable battery, and wherein the charging period of time is approximately 5 minutes.

26. The device of claim 22, further comprising the rechargeable battery.

27. A charger apparatus comprising:
a rechargeable battery having at least one rechargeable electrochemical cell the rechargeable battery having a battery identification mechanism configured to communicate identification information representative of a corresponding battery capacity associated with the rechargeable battery;
a charging compartment configured to receive the rechargeable battery, the charging compartment including:
charging terminals configured to be coupled to respective terminals of the rechargeable battery, and
a battery identification read mechanism configured to communicate with the battery identification mechanism of the rechargeable battery, and to receive the identification information; and
a controller configured to;
determine the corresponding battery capacity based on the identification information of the rechargeable battery;
determine a charging current level to be applied to the rechargeable battery based on the determined corresponding battery capacity such that the battery achieves a pre-determined charge that is reached within a charging period of time of 15 minutes or less; and
apply a charging current having substantially about the determined current level to the battery.

28. A docking station system comprising;
a charging compartment configured to receive a battery-operable device having at least one rechargeable battery, the charging compartment including;
connections to connect to respective connections of the battery-operable device, and
an identification read mechanism configured to communicate with an identification mechanism of the battery-operable device, the identification mechanism configured to communicate identification information representative of a battery capacity associated with the at least one rechargeable battery; and
a controller configured to:
determine the corresponding battery capacity based on the communicated identification information; and
determine a charging current level to be applied to the at least one rechargeable battery of the battery-operable device based on the determined corresponding battery capacity such that the at least one rechargeable battery achieves a pre-determined charge that is reached within a charging period of time of 15 minutes or less.

29. The system of claim 28, further comprising the battery-operable device.

30. The system of claim 29, wherein the battery-operable device includes one of: a mobile phone, a Personal Digital Assistant (PDA), a digital camera, an audio device and a multimedia device.
